(19) United States
(12) Patent Application Publication
(10) Pub. No.: US 2025/0027715 A1
(43) Pub. Date: Jan. 23, 2025

(54) FURNACE

(71) Applicants: Moris Moshe PEREZ, Tverya (IL); Hadar PEREZ, Tverya (IL)

(72) Inventors: Moris Moshe PEREZ, Tverya (IL); Hadar PEREZ, Tverya (IL)

(21) Appl. No.: 18/236,415

(22) Filed: Aug. 22, 2023

Related U.S. Application Data
(60) Provisional application No. 63/419,715, filed on Oct. 27, 2022.

(51) Int. Cl. F27B 14/08; F27B 14/14

(52) U.S. Cl. CPC F27B 14/08; F27B 14/14; F27B 2014/0837

(57) ABSTRACT

A furnace, including: a metallic pot, for housing fire; and means for cooling the metallic pot, the means being a water tank attaching an external wall of the metallic pot and/or an air blower, for producing an airstream attaching an internal wall of the metallic pot.

### CROSS-REFERENCE TO RELATED APPLICATIONS

This application claims the benefit of priority from Israel Patent Application No. 304659, filed Jul. 23, 2023, the disclosure of which is incorporated herein by reference.

### TECHNICAL FIELD

The invention relates to the field of furnaces.

### BACKGROUND

A furnace is an enclosed structure in which material can be heated to very high temperatures, e.g. for smelting metals.

The structure is either durable to the heat, such as of stones, or being not attached to the heat source. The typical non-attaching is applied by liquefied petroleum gas (LPG) fire.

Thus, conventionally, stone structures are heated by wood or coal, whereas iron structures are heated by LPG.

However, the above two combinations are disadvantaged, since wood is advantaged over LPG, and iron structures for a furnace are advantaged over stones structure.

Thus, to melt for example aluminum, small gas furnaces are used, thus are unsafe and expensive and its operating process is problematic and inefficient.

There is a long felt need to provide a solution to the above-mentioned and other problems of the prior art.

### SUMMARY

A furnace (10), including:
a metallic pot (36), for housing fire (66); and
means for cooling the metallic pot (36), the means being a water tank (40) attaching an external wall (74A) of the metallic pot (36) and/or an air blower (60), for producing an airstream (62A) attaching an internal wall (74B) of the metallic pot (36).

### BRIEF DESCRIPTION OF THE DRAWINGS

Embodiments, features, and aspects of the invention are described herein in conjunction with the following drawings:

FIG. 1 depicts a melting apparatus according to one embodiment of the invention.

FIG. 2 is a sectional view of the melting apparatus of FIG. 1, for showing elements below the ground.

FIG. 3 is a sectional cut view of the melting apparatus of FIG. 1.

FIG. 4 is a top view of the pot of FIG. 3.

FIG. 5 is a front sectional view of the port and the chamber.

The drawings are not necessarily drawn to scale.

### DETAILED DESCRIPTION

The invention will be understood from the following detailed description of embodiments of the invention, which are meant to be descriptive and not limiting. For the sake of brevity, some well-known features are not described in detail.

The reference numbers have been used to point out elements in the embodiments described and illustrated herein, in order to facilitate the understanding of the invention. They are meant to be merely illustrative, and not limiting. Also, the foregoing embodiments of the invention have been described and illustrated in conjunction with systems and methods thereof, which are meant to be merely illustrative, and not limiting.

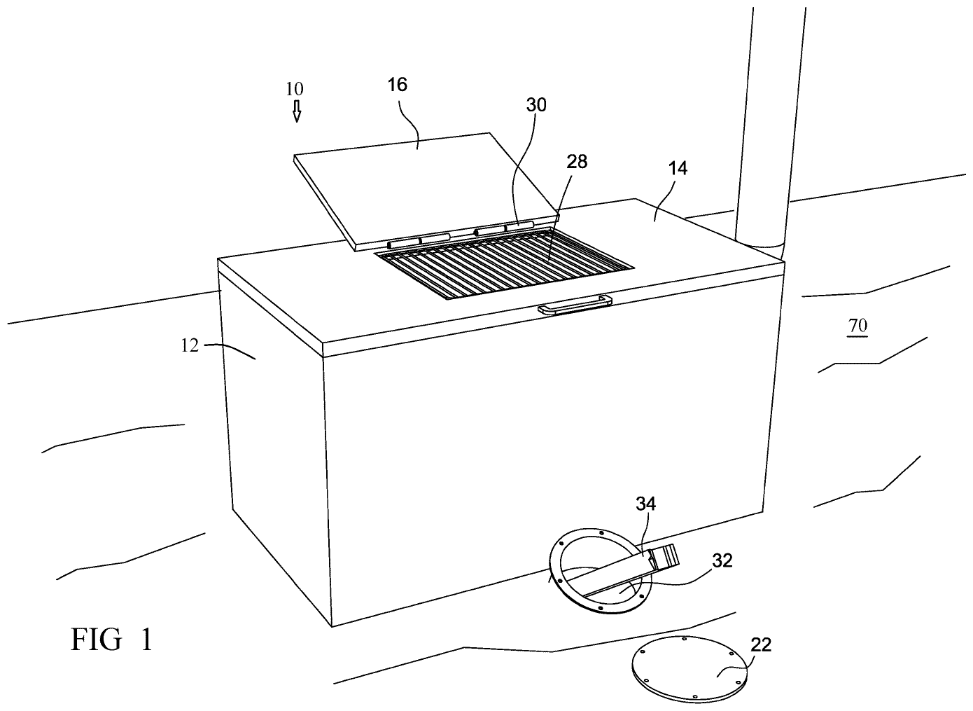

FIG. 1 depicts a melting apparatus according to one embodiment of the invention.

A furnace 10 according to one embodiment of the invention, includes a chamber 12 disposed on the ground 70; and an inlet 32, for inserting wood 34 therethrough to below the ground 70.

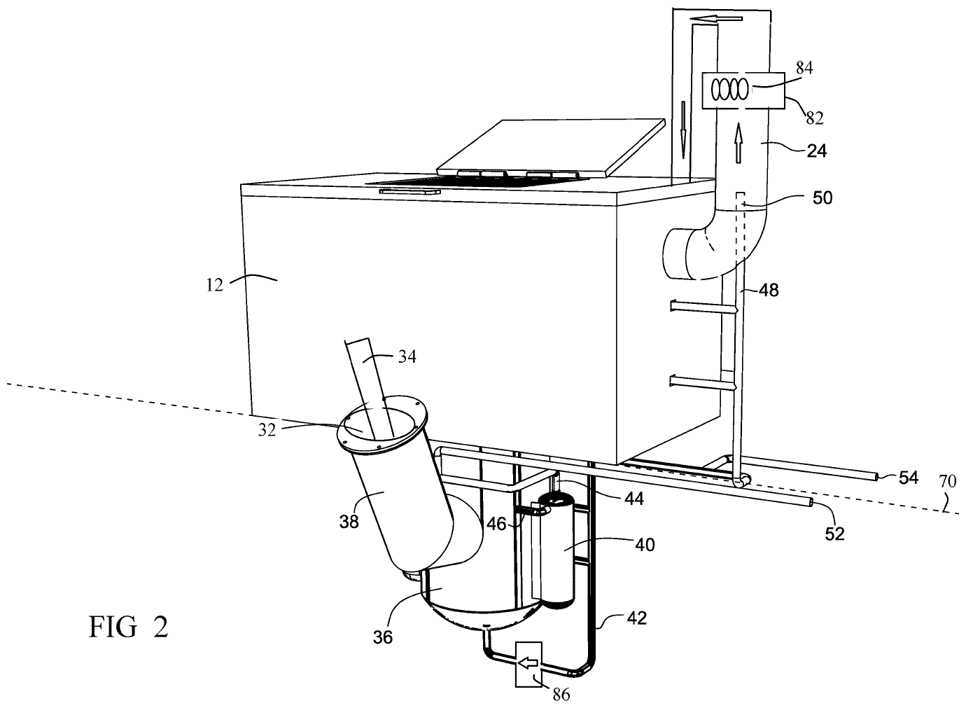

FIG. 2 is a sectional view of the melting apparatus of FIG. 1, for showing elements below the ground.

A pot 36 is disposed below chamber 12 and below the ground 70.

Inlet 32 is of a pipe 38, for leading wood 34 into pot 36.

FIG. 3 is a sectional cut view of the melting apparatus of FIG. 1.

Upon the insertion, wood 34 is disposed on the bottom 72 of pot 36, and turns to fire 66, for melting aluminum or other pieces 80 disposed on the floor of chamber 12. Wood 34 is a renewable energy source.

Fire 66 attached to bottom 72 of pot 36 is problematic, since it might melt pot 36.

A first solution to the heat problem is by attaching water tanks 40 to the external wall of pot 36, for cooling pot 36. The water of water tanks 40 is circulated by water pipes 52 communicating with water tanks 40 by a water pump 82.

Chamber 12 and pot 36 have an opening 56 therebetween.

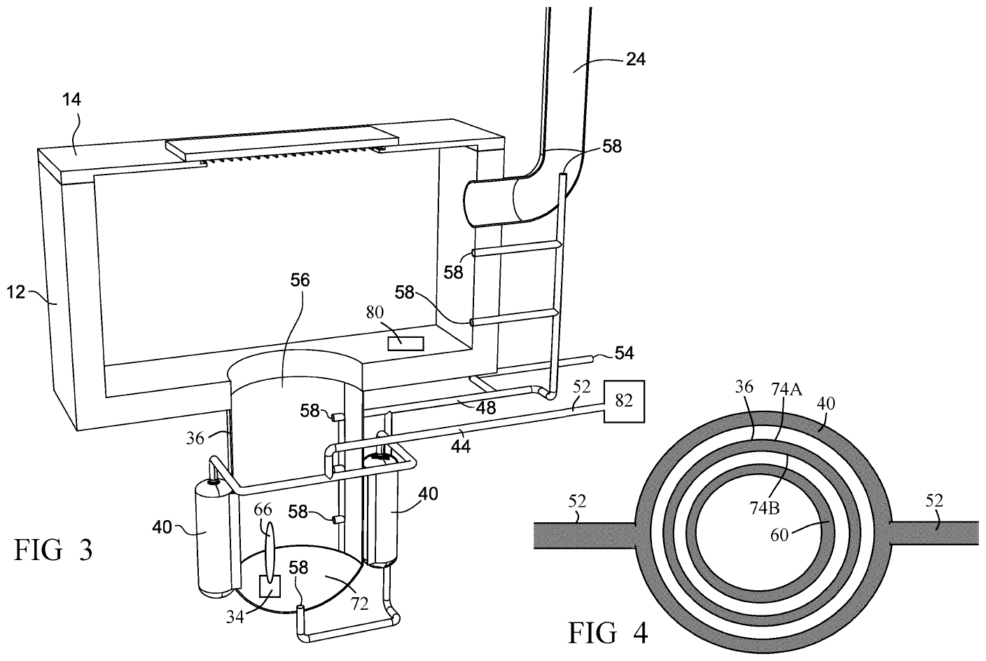

FIG. 4 is a top view of the pot of FIG. 3.

Tanks 40 may be a single peripheral tank surrounding pot 36, for attaching the entire external surface 74A of pot 36, for increasing the heat exchange from pot 36 to water 40.

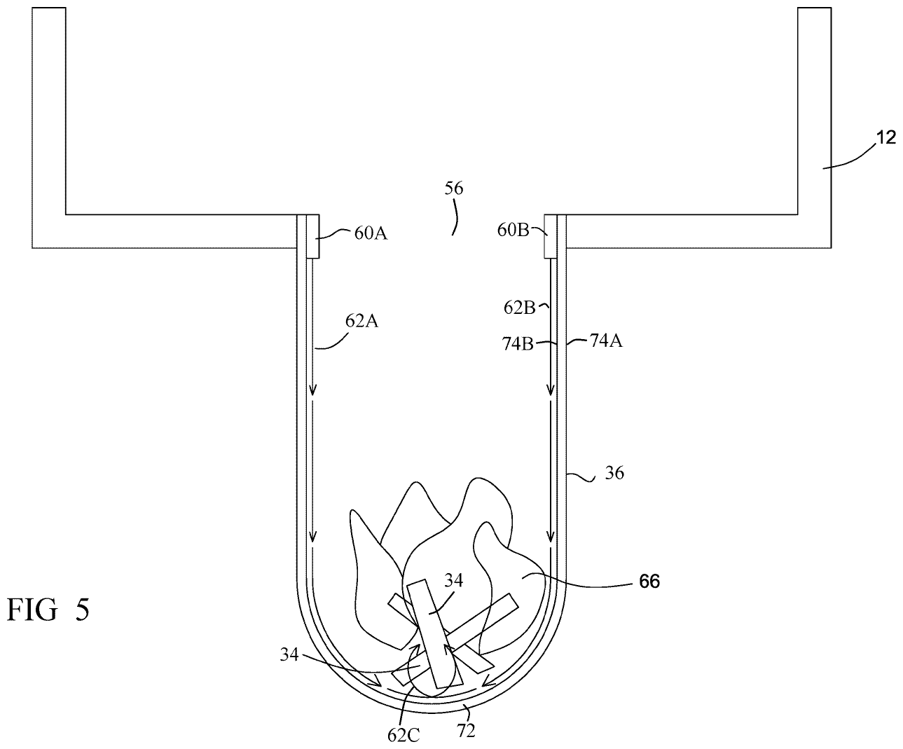

FIG. 5 is a front sectional view of the port and the chamber.

A second solution to the heat problem is by shaping the bottom 72 of pot 36 rounded, and providing an airstreams 62A and 62B by an air blower 60 along the internal wall 74B of pot 36.

Airstreams 62A and 62B block fire 66 from attaching internal wall 74B, thus decreasing the heating thereof.

Airstreams 62A and 62B are directed downwards toward bottom 72 of pot 36, thus they meet at the center of bottom 72 and join to an airstream 62C directed upwards. Thus, airstream 62C lift fire 66 away from bottom 72, thus not attaching it and less heating it.

Referring again to FIG. 4, air blower 60 is peripheral. Thus, and referring again to FIG. 5, airstreams 62A and 62B are examples only of two opposing sides.

A computerized system introduces water through an opening (52) into a pipe (44) that introduces the water into the tanks (40), the water evaporates and cools the pot (36) and turns into steam that exits into the pot through an outlet pipe (46).

Another system contains piping (42) that introduces high-pressure air into the pot (36) and also into the upper part of the pot through piping (48) and a compressor 86 and into the chimney (24) through pipe (50), the air flow ignites the fire and the air flow in the chimney (50) helps in getting the air and smoke out. The air pressure enters through an opening (54).

The cooling tank (40) is cooled by the cooling pipe (44) and the water inlet opening (52). A fire extinguishing system includes piping (48) that flows high pressure air (58) that enters the lower pot and the chamber (12) and the chimney (24). The air pressure enters the piping (48) through an opening (54). The heat from the lower pot exits through an opening (56).

Thus provided is a pneumatic melting reactor for the purpose of recycling the environment through the use of existing materials that are recycled instead of being thrown away as waste. For example, aluminum contains a combustion chamber to which pipes are connected that supply it with compressed air from an external compressor. The compressed air ignites the fire in the combustion chamber operating on firewood

The reactor serves as the combustion chamber and contains on both sides cooling chambers into which water is introduced only when the temperature of the reactor rises above the temperature defined in the system. This temperature is measured by a sensor installed on the wall of the reactor.

In case the temperature in the reactor is too high, the controller of the system opens a faucet and flows normal water into the wall cells.

In the cooling chambers, the water turns into steam and is transferred through an outlet to the pipe and the steam is emitted through a chimney. The contact of the cooling tanks with the reactor cools the reactor to the required selected temperature.

The air pressure coming from the compressor is sent through another pipe to the chimney and optimizes removing the smoke from the reactor and the chimney.

The reactor contains coal for introducing wood. The reactor is installed underground and above it is installed the furnace house in the form of a hollow cube that is coated with cast concrete and contains an opening in the upper part through which aluminum parts are inserted, for example a car engine head, aluminum scrap, etc.

A grid may be disposed on the upper part of the chamber to use for cooking food for barbecue, etc. The chamber may form a tool for smoking, meat, etc.

The system may include a temperature control that will allow a variable supply of air into the reactor according to the user's choice.

According to another configuration, the system will contain additional heating by gas, for example “butane”.

The system works with a combination of wood and compressed air to increase combustion to allow the reactor to provide 1500 degrees Celsius. Compressed air ignites the heat.

In order to provide 1500 degrees C., The stove works on burning a very small amount of wood. Once the chamber works, the computer blows compressed air into the chamber from several different directions. Once there is combustion in the melting reactor and the smoke is heated, a nucleus of heat is maintained.

The smoke to heated to the highest temperature the smoke helps the flame rate increase, and eventually the smoke itself catches fire and the rate of smoke flow decreases.

The smoke exiting the chimney is transferred to a filter tank, and goes on to a recombination process in order to turn the smoke into natural gas.

CO2 may be turned into fuel/gas based on enzymes isolated from bacteria to power the chemical reactions which convert CO2 into fuel, a process called electrolysis Enzymes are more efficient than other catalysts, such as gold, but they are highly sensitive to their local chemical environment

Once the smoke is cooled and filtered and has returned back to be gas fuel, it is heated again.

Referring to FIG. 2, the smoke flows to a separate system 82 that is wrapped in electromagnetic coils 84. The smoke passes through it with the help of a special filtering filter that separates the natural gas from the smoke

And the smoke will turn into gas and it will be possible to use it for the gas industry for various uses, including in the chamber.

Thus, in one aspect, the invention is directed to a furnace (10), including:
a metallic pot (36), for housing fire (66); and
means for cooling the metallic pot (36), the means including at least one member consisting of:
   at least one water tank (40) attaching an external wall (74A) of the metallic pot (36);
   at least one air blower (60), for producing an airstream (62A) attaching an internal wall (74B) of the metallic pot (36).

The furnace (10) may further include at least one water pipe (52) communicating with the at least one water tank (40), for circulating water therethrough.

The water tank (40) may be peripheral thereby surrounding the pot (36).

The air blower (60) may be peripheral.

The bottom (72) of the pot (36) may be rounded, for lifting the fire.

In the figures and description herein, the following reference numbers (Reference Signs List) have been mentioned:
number 10 denotes the furnace according to one embodiment of the invention;
12: chamber;
14, 16: openable covers;
22: cover for covering inlet 32, while burning;
24: chimney;
30: hinge;
32: inlet;
28: grid;
30: pot/reactor;
23: wood or coal or other substance for being burnt;
70: ground;

The foregoing description and illustrations of the embodiments of the invention have been presented for the purpose of illustration, and are not intended to be exhaustive or to limit the invention to the above description in any form.

Any term that has been defined above and used in the claims should be interpreted according to this definition.

The reference numbers in the claims are not a part of the claims, but rather used for facilitating the reading thereof. These reference numbers should not be interpreted as limiting the claims in any form.

What is claimed is:

1. A furnace, comprising:
a metallic pot, for housing fire (66); and
means for cooling said metallic pot, said means including at least one member consisting of:
a) at least one water tank attaching an external wall of said metallic pot;
b) at least one air blower, for producing an airstream attaching an internal wall of said metallic pot.

2. The furnace according to claim 1, further comprising at least one water pipe communicating with said at least one water tank, for circulating water therethrough.

3. The furnace according to claim 1, wherein said at least one water tank is peripheral thereby surrounding said pot.

4. The furnace according to claim 1, wherein said at least one air blower is peripheral.

5. The furnace according to claim 1, wherein a bottom of said pot is rounded.

6. The furnace according to claim 1, further comprising:
an air compressor for compressing air into said pot.

7. The furnace according to claim 1, further comprising:
a chimney; and
a system comprising electromagnetic coils, for turning smoke exiting said chimney to gas fuel, for flowing thereof into said pot.
